(19) United States
(12) Patent Application Publication
(10) Pub. No.: US 2013/0092008 A1
(43) Pub. Date: Apr. 18, 2013

(54) Multi-Gauge Guitar Pick

(71) Applicant: William O. Murphy, Traverse City, MI (US)

(72) Inventor: William O. Murphy, Traverse City, MI (US)

(21) Appl. No.: 13/273,457

(22) Filed: Oct. 14, 2011

(51) Int. Cl. G10D 3/16

(52) U.S. Cl. 84/322

(57) ABSTRACT

A guitar pick with at least three corners, at least two of which have a different gauge or stiffness to produce different sounds on a guitar. In the preferred form, the pick is generally symmetrical and all corners are “playing” corners of different gauge, intended for use across the strings of a guitar.

### RELATED APPLICATIONS/PRIORITY BENEFIT CLAIM

None.

### FIELD

The subject matter of the present application is in the field of flat picks for guitars and similar stringed instruments.

### BACKGROUND

Flat picks for guitars are typically made from triangular pieces of material such as plastic, horn, metal, stone, shell, bone, wood, and others. The picks generally have flat bodies with two more-rounded corners for grasping between thumb and finger, and a less-rounded playing corner or tip used to strum or pluck the strings of the guitar. Picks are often differentiated by gauge, meaning their relative stiffness or degree of flexibility. Different stiffness is achieved by using different thicknesses of the same material, or by using different materials. Picks of different gauge produce different sounds and/or playability, given the same instrument.

Guitar players who want to produce different sounds from a single instrument often keep an assortment of picks to choose from during a music session.

### BRIEF SUMMARY

I have invented a flat guitar pick with a generally flat body having at least three corners, at least two of which corners are “playing” corners of different gauge.

In a further form, all of the pick's corners are playing corners, and they are all of different gauge.

The difference in gauge between playing corners can be achieved in different ways, including but not limited to the use of different thicknesses of the same material, or the use of different materials. “Gauge” will accordingly be used to mean differences in relative stiffness or degree of flexibility of the playing corners, however achieved.

“Guitar” will be used to mean any stringed instrument which can be played with a corner of a flat pick, and whose sound can be modified by using picks of different gauge.

“Pick” will be used to mean a flat style guitar pick.

“Corner” can include rounded, flattened (truncated), or sharp ends or edges.

These and other features and advantages of the invention will become apparent from the detailed description below, in light of the accompanying drawings.

### BRIEF DESCRIPTION OF THE DRAWINGS

FIG. 1 is a perspective view of an example guitar pick according to the invention.

FIG. 2 is a top plan view of the guitar pick of FIG. 1.

FIGS. 3 through 5 are side section views of the three corners of the pick of FIG. 1, respectively.

FIG. 6 is a plan view of a pick according similar to the pick of FIG. 1, but with more than three corners.

FIG. 7 is a plan view of a pick similar to FIG. 1, wherein different materials have been unified into a single pick.

### DETAILED DESCRIPTION

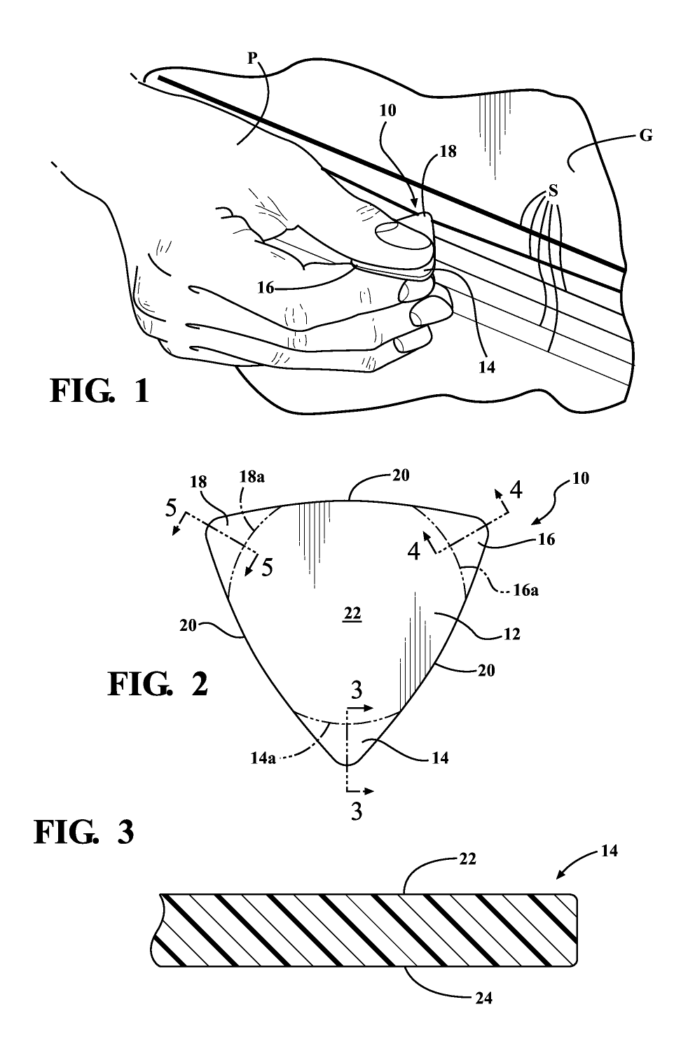

Referring first to FIGS. 1 through 5, a guitar pick 10 is shown in exemplary form in order to teach how to make and use the claimed invention. As shown in FIG. 1, pick 10 is generally grasped between the thumb and forefinger of a player P, and one corner used to pluck or strum the strings S of a guitar G.

As best shown in FIGS. 1 and 2, pick 10 is a flat style pick having a generally flat body 12, three corners 14, 16, and 18, sides 20, and top and bottom surfaces 22 and 24 (FIG. 3). My inventive pick 10 has at least two playing corners, and (as shown in this illustrated example) preferably all of the corners of pick 10 are playing corners. It accordingly is desirable and preferred, although not necessary, to form the playing corners of pick 10 with a similar size and shape. Where all corners of the pick are playing corners, it may also be desirable to make pick 10 generally symmetrical, with sides 20 of generally even length and edge contour, so that the area of the pick grasped by a player as the “base” relative to any one playing corner is similar, no matter which playing corner is being used. Although sides 20 are shown as curved, they may be straight or irregular.

Body 12 is generally flat or planar, but this can include various surface contours, textures, apertures, and other irregularities along the top 22 and/or bottom 24, as long as the pick can still be considered a “flat” guitar pick as understood by those skilled in the art of guitar picks.

Illustrated pick 10 is formed from a single material, for example (and without limitation) plastic such as nylon or Tortex™, animal horn, bone, shell, stone, wood, or metal, using known processes such as injection molding, carving, stamping and/or machining. Body 12 and corners 14, 16, and 18 are accordingly made from the same material.

Corners 14, 16 and 18 are the playing portions of pick 10, meaning they are the portions intended for primary musical contact with the strings of a guitar. The corners include not just the outermost ends or edges of the corner material, but a playing region whose area can vary depending on factors such as (but not limited to) the overall size of the pick, the pick material, the intended style of play, and the preference or skill level of the intended user. Corners 14, 16, and 18 are schematically defined in the illustrated example of FIGS. 3 through 5 as regions bounded by broken lines 14a, 16a, and 18a. Although the corners are shown as being the same size, they could also vary in size.

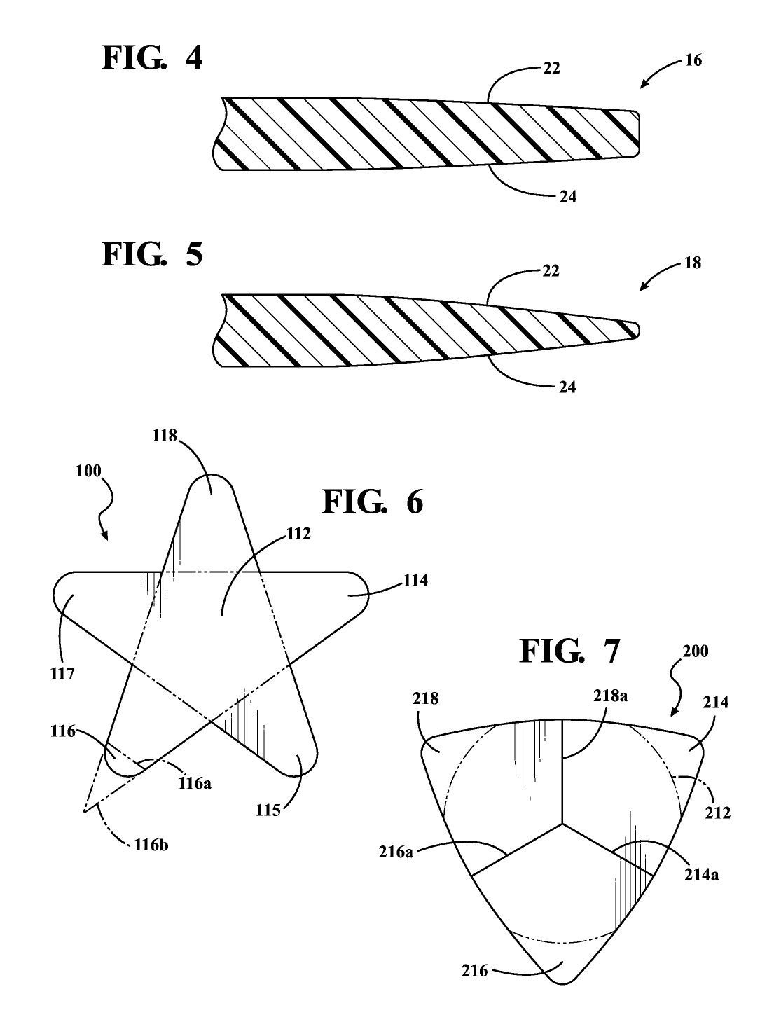

Illustrated corners 14, 16 and 18 all have different gauge to produce different sounds or feel when engaging the strings of a guitar. By way of non-limiting example, corner 14 may be “hard”; corner 16 “medium”; and corner 18 “soft”. Other terms used to describe differences in gauge include “heavy/medium/light”, “stiff/flexible”, and numbers denoting the actual thickness. The different gauge of the three corners is achieved in the illustrated example with different thicknesses of the pick material, as shown schematically in FIG. 3 (hard corner 14), FIG. 4 (medium corner 16), and FIG. 5 (soft corner 18). Each corner may have a uniform thickness or a varying thickness, may be symmetric or asymmetric, or may have other cross-sectional variations that produce different sounds or playing feel when each corner is applied to the strings of a guitar. Such variations may be already known, or they may be new ones created as guitar players endlessly experiment to find just the right sound or feel for their respective styles of play.

In the illustrated example, pick 10 is molded from a plastic such as nylon, and the differing gauge of the corners is formed as the pick is molded. Hard corner 14 has a uniform thickness cross-section, medium corner 16 has a tapered (thinner) cross-section, and soft corner 18 has a more-tapered (thinnest) cross-section.

While the pick 10 illustrated in FIGS. 1 through 5 is shown in a triangular shape with three corners, picks with more than three corners are possible. FIG. 6 shows a “star” pick 100 with body 112 and five corners 114, 115, 116, 117, and 118 having different gauge relative to one another. Other shapes and numbers of corners are also possible.

FIG. 6 is also used to illustrate other possibilities for the shape of the “corner”, which can be rounded as illustrated in solid lines, but could also include other shapes such as truncated or squared ends (broken line 116a) and pointed ends (broken lines 116b). A single pick could also include corners having different shapes (for example, one corner rounded, one corner squared, one corner pointed), which may be used to produce different sounds or playing feel, and/or which may be used to provide a visual or tactile distinction to the player to distinguish the differently-gauged corners. The terminal ends of the corners could be blunt or tapered, as desired.

FIG. 7 shows an alternate triangular pick 200, in which different corner gauge is achieved by unifying three different materials into a single pick, for example three different types of plastic, one for each corner 214, 216, and 218; or, three unrelated materials, such as plastic for corner 214, bone for corner 216, and metal for corner 218. The three different corner materials are shown joined at lines 214a, 216a, and 218a to form the pick body 212, which is schematically illustrated by broken lines and includes portions of all three materials.

It may also be possible to attach two or more corners of different material to a pick body adapted to receive them. For example, the pick 10 shown in FIGS. 1 and 2 could be formed by inserting or molding corners 14, 16, and 18 of three different materials into a pick body 12 of yet a different (fourth) material.

In each of the pick examples illustrated above, it is possible and may be desirable to color or otherwise visually mark or distinguish the differently-gauged corners to aid the guitar player in making rapid changes from one corner to another during play. It may also be possible to give the differently-gauged corners a tactile difference, for example with different surface textures, including Braille characters, so that a player might be able to change from one corner to another by feel, or to provide nonslip qualities.

The use of my multi-gauged guitar pick allows a player to reduce the number of picks needed to elicit a range of sounds and/or playing feel from a single instrument.

While a simple flat pick is illustrated, the flat pick body could be supplemented with other features that would complement the playing corners of different gauge. For example, pick 10 could be modified with a swivel of known type to make changing from one corner to another easier.

It will finally be understood that the disclosed embodiments represent presently preferred examples of how to make and use the claimed invention, but are intended to enable rather than limit the invention as defined by the claims. Variations and modifications of the illustrated examples in the foregoing written specification and drawings may be possible without departing from the scope of the invention as defined in the claims. It should further be understood that to the extent the term “invention” is used in the written specification, it is not to be construed as a limiting term as to number of claimed or disclosed inventions or discoveries or the scope of any such invention or discovery, but as a term which has long been conveniently and widely used to describe new and useful improvements in science and the useful arts. The scope of the invention is accordingly defined by the following claims:

What is claimed:

1. A guitar pick comprising:
a generally flat body comprising at least three corners, wherein at least two of the corners are playing corners of different gauge.

2. The guitar pick of claim 1, wherein all of the corners are of different gauge.

3. The guitar pick of claim 1, where the different gauge comprises a different thickness for each playing corner.

4. The guitar pick of claim 1, wherein the different gauge comprises a different stiffness for each playing corner.

5. The guitar pick of claim 1, wherein the different gauge comprises a different material for each playing corner.

6. The guitar pick of claim 1, wherein the at least two corners are made of the same material.

7. The guitar pick of claim 5, wherein the at least two corners are made of the same material as the pick body.

8. The guitar pick of claim 1, wherein the at least two corners are made of different material.

9. The guitar pick of claim 7, wherein the at least two corners are made of different material than the pick body.

10. The guitar pick of claim 1, wherein the at least two corners are visually distinct.

11. The guitar pick of claim 1, where the at least two corners are tactilely distinct.
